(19) United States
(12) Patent Application Publication
(10) Pub. No.: US 2002/0051833 A1
(43) Pub. Date: May 2, 2002

(54) Apparatus for taking out molded products

(75) Inventor: Tetsurou Shiozaki, Kyoto-shi (JP)

Correspondence Address: FITCH EVEN TABIN AND FLANNERY, 120 SOUTH LA SALLE STREET, SUITE 1600, CHICAGO, IL, 60603-3406, US

(73) Assignee: Kabushiki Kaisha Yushin Seiki, Kyoto-shi (JP)

(21) Appl. No.: 09/984,736

(22) Filed: Oct. 31, 2001

(30) Foreign Application Priority Data
Nov. 1, 2000 (JP) 2000-334814

(51) Int. Cl. B29C 45/80

(52) U.S. Cl. 425/139; 425/165; 425/556

(57) ABSTRACT

An apparatus for taking out a molded product including an ejection-waiting-time adjusting section 51 and a pull-out-waiting-time adjusting section 52. The ejection-waiting-time adjusting section 51 reduces an ejection waiting time Ti of an ejection timer 3 and finely adjusts the ejection waiting time Ti so that a response time Tj may not become shorter than an absorption-pressure-rise expected time Ts nearly when the response time Tj agrees with the absorption-pressure-rise expected tome Ts. The pull-out-waiting-time adjusting section 52 reduces a pull-out waiting time Ta of a pull-out timer 4 and finely adjusts the pull-out waiting time Ta so that a completion moment of the pull-out waiting time Ta may not be earlier than a detection moment B of a preset pressure value P1. With this, it is possible to provide optimal timing of an ejection starting moment and a molded-product pull-out starting moment and also adjust them automatically.

### BACKGROUND OF THE INVENTION

1. Field of the Invention

The present invention relates to a technological field of a take-out apparatus for taking out a molded product by absorbing it off from a pair of die halves using a retaining mechanism section equipped with an absorbing mechanism and, more particularly to, an apparatus for taking out a molded product at effective timings at which it is taken out from a pair of die halves and at which it is pulled out of them.

2. Description of the Prior Art

According to the basic operations of an injection-molding machine, as shown in FIG. 10, after a pair of die halves are clamped (FIG. 10(a)), a resin is injected into the die cavities (FIG. 10(b)) and, when the resin has been cooled (FIG. 10(c)), the die halves are opened (FIG. 10(d)), to eject a molded product using an ejecting mechanism section equipped to the die-halves mechanism and then take it out from the die halves using a molded-product take-out apparatus (FIG. 10(e)).

This take-out apparatus is provided with a retaining mechanism section, a movement mechanism section, and a position detecting means.

This retaining mechanism section is comprised of lateral-movement, vertical-movement, and forward/backward movement arm, to take out a molded product from the die halves. This retaining mechanism section has at its tip an absorbing mechanism to absorb and grip a molded product. The movement mechanism section is comprised of a servo motor etc., to move the retaining mechanism section. The position detecting means detects a position of the retaining mechanism section based on, e.g. an amount of actuation by the movement mechanism. This position detecting means always detects a movement position each time the retaining mechanism section starts to move from a waiting position according to a take-out signal.

As for operations by the take-out apparatus of taking out a molded product, as shown in FIG. 11, the retaining mechanism section 7 of the take-out apparatus normally stands still at the waiting position (A) and starts to move when the movable type 40 of the die halves 30 and 40 moves to complete opening thereof and a take-out signal is issued. Then, the retaining mechanism section 7(c)hanges its moving direction at the die-halves proceeding position (B) and stops at a moment when it has arrived at the molded-product take-out position (C). Then, the ejecting mechanism section 8 on the side of the die-halves mechanism is actuated to separate a molded product 20 from the die half 40, which product 20 is subsequently absorbed by the absorbing mechanism 9 of the retaining mechanism section 7. In this state, the retaining mechanism section 7 is moved backward to the pull-out position (D) to pull out the molded product 20 and then moves to a molded-product opening position (not shown) to release absorption by the absorbing mechanism 9 to retrieve the molded product 20 and then returns to its initial waiting position (A).

This take-out operations are performed at such a timing as shown in FIG. 12. Specifically, immediately when the opening of the die halves is completed and the take-out signal Sz is issued, as shown in FIG. 12(a), the retaining mechanism section 7 starts to move from the waiting position (A) to the die-halves proceeding position (B) and, after an elapse of a time Tz, changes its moving direction at the die-halves proceeding position (B) and, as shown in FIG. 12(b), moves toward the take-out position (C) and, after an elapse of a time Ty, arrives at the take-out position (C). Then, as shown in FIG. 12(c), an eject signal Se is output to operate the ejecting mechanism section 8 to separate the molded product 20 from the die half 40 and, after a time Te that is the time until this ejecting movement is completed, as shown in FIG. 12(d), a time Tx is awaited until absorption of the molded product 20 is completed by the retaining mechanism section 7. When a pull-out signal Sx is output after an elapse of the time Tx, the retaining mechanism section 7 moves back to the pull-out position (D) after an elapse of a time Ty′ as shown in FIG. 12(e).

Therefore, a process from outputting of the take-out signal Sz until the molded product 20 is absorbed takes comparatively a long time of Tz+Ty+Te+Tx, which leads to a decrease in operational efficiency.

To guard against this, Japanese Utility Model Publication (KOKOKU) No. Hei 7-27145 (Japanese Utility Model No. 2111643) proposes as follows: as shown in FIG. 13, the retaining mechanism section 7 is caused to move concurrently with ejection by the ejecting mechanism section 8, to calculate beforehand a timing at which the eject signal Se is output so that a timing at which the retaining mechanism section 7 arrives at the take-out position (C) may agree with a timing at which the ejecting mechanism section 8 completes its ejection operation (see FIG. 13C), thus reducing the total take-out time for taking out the molded product by the ejection operation time Te as compared to the take-out apparatus following a timing chart of FIG. 12.

However, between an initiation time and an operating time of the ejecting mechanism section 8 on the side of the die-halves mechanism, the viscous resistance of an oil may vary due to a change in the temperature of the interior of a hydraulic cylinder or a lubricant employed. Specifically, the oil temperature rises during operation as compared to a temperature at time of initiation to decrease the viscous resistance, thus accelerating the speed of ejection by the ejecting mechanism section 8. Also, the ejection time of the ejecting mechanism section 8 may vary due to a variety of factors such as a condition of the hydraulic cylinder, a condition of an ejecting pin for pricking the molded product, etc.

In this case, since the take-out apparatus shown in the timing chart of FIG. 13 calculates a timing for outputting the eject signal Se beforehand to thereby make a time at which the retaining mechanism section 7 arrives at the take-out position coincident with a time at which ejection by the ejecting mechanism section 8 is completed, when the ejecting speed of the ejecting mechanism section 8 is accelerated, the ejection of the molded product 20 may be completed before the arrival of the retaining mechanism section 7. In such a case, the molded product 20 may encounter imperfect absorption, accompanied by a problem of dropping of the molded product.

Also, to detect a completion moment of an ejecting operation by the ejecting mechanism section 8, it is necessary to dispose a detecting means such as a proximity switch at a desired position on the die halves (30, 40) so that a signal may be transmitted from there to the take-out apparatus. Disposing such a detecting means on the die halves (30, 40) may further complicate the intricately designed die halves (30, 40), cause an erroneous operation as an operation of the die halves (30, 40) proceeds with time, or damage the die halves (30, 40). Accordingly, it is practically difficult to accurately detect a completion time of ejecting by the ejecting mechanism section 8 (terminal time point of its forward movement) only on the side of the take-out apparatus without providing the above-mentioned detecting means.

The above-mentioned absorption-waiting time Tx should idealistically be preset at just value enough for the absorbing mechanism 9 to have a sufficient negative pressure (vacuum pressure) for holding the molded product without dropping it during the movement of the retaining mechanism section 7, thus minimizing a loss in time.

Practically, however, this time Tx is preset at a value longer than a time required to complete absorption of the molded product, taking into account a spare time. This is done so because the ejecting speed may vary between the initiation time and the operating time of the ejecting mechanism section 8, owing to a change in its apparatus environments, which may possibly accelerate a pull-out timing of the retaining mechanism section 7 to thereby give a shift in the absorbing timing and hence imperfect absorption of the molded product, thus resulting in dropping of the molded product during the movement of the retaining mechanism section 7. Also, there are large irregularities in setting of this absorption-waiting time Tx among the relevant operators, so that that time has been preset taking a considerable spare time into account. Accordingly, this absorption-waiting time Tx has decreased the overall operational efficiency in an take-out operation of the molded product which is repeated many times, thus deteriorating the production efficiency of the molded product.

Also, if the absorption timing is shifted as mentioned above, a skilled person with a long-time experience is required to pull out the molded product properly by adjusting the preset timer value to re-set the pull-out waiting time including the absorption-waiting time Tx and adjusting the outputting timing of the eject signal Se of the ejecting mechanism section 8. Not everyone can adjust the timings easily.

Further, if the absorbing mechanism 9 is cracked, chipped at its tip, or otherwise damaged, a normal pull-out operation cannot be restored even by the above-mentioned timing adjustment, and the operator must always monitor the apparatus to detect such imperfect absorption.

### SUMMARY OF THE INVENTION

In view of the above, it is an object of the invention to provide an apparatus for taking out a molded product separated from die halves by an ejecting mechanism section after die opening and held by a retaining mechanism section equipped with an absorbing mechanism, in which an ejection time of the ejecting mechanism section can be grasped and also a pull-out-waiting time of the molded product can be known accurately without disposing a detecting means on the side of a die mechanism to thereby reduce the total pull-out time of the molded product and also enable automatic adjustment of an ejection starting moment of the ejecting mechanism section and a pull-out starting moment of the molded product according to a state of the apparatus, thus resulting in an improvement of the production efficiency of the molded product.

To achieve this purpose, a molded-product take-out apparatus according to the invention includes:

an absorption-pressure detecting means for detecting an absorption pressure of the absorbing mechanism when it has absorbed a molded product;

a measuring means for measuring a response time elapsing from an arrival time of the retaining mechanism section at the molded-product take-out position until a pressure value detected by the-absorption pressure detecting means reaches a preset pressure value;

a first time-measuring means for measuring an ejection waiting time elapsing from initiation of a take-out operation of the retaining mechanism section until the ejecting mechanism section reaches an ejection starting moment;

a second time-measuring means for a pull-out waiting time elapsing from an arrival time of the retaining mechanism section at the molded-product take-out position until the retaining mechanism section starts its operation;

an ejection waiting-time adjusting section for reducing the ejection waiting time measured by the first time-measuring means and adjusting the ejection waiting time slightly so that the response time may not become shorter than an absorption-pressure-rise expected time nearly when the response time agrees with a preset value of the absorption-pressure-rise expected time; and

a pull-out-waiting-time adjusting section for reducing the pull-out waiting time measured by the second time-measuring means and adjusting the pull-out waiting time finely so that a completion time of the pull-out waiting time may not become shorter than a detection moment of said preset pressure value by said absorption-pressure-rise detecting means.

When the ejection starting time of the ejecting mechanism section agrees with the take-out position arrival time of the retaining mechanism section, the response time measured by the measuring means contains an ejecting time of the ejecting mechanism section and an absorption-pressure rise time elapsing from a time when the absorbing mechanism starts to absorb the molded product until the absorption pressure reaches the preset pressure value.

In this case, the preset pressure value is a negative pressure (vacuum pressure) required to absorb the molded product by the absorbing mechanism without drop it and is determined on the basis of experiments and experiences, having a value of, e.g., 30 KPa or so as a standard. Also, the absorption-pressure-rise expected time preset by the ejection waiting-time adjusting section is such a value of a time which may be considered to be the absorption-pressure rise time that is determined on the basis of experiments and experiences, taking on a value of, e.g., 30 m sec or so as a standard.

When the ejection-waiting-time adjusting section has reduced the ejection waiting time so that the response time may roughly agree with the absorption-pressure-rise expected time, an ejection waiting time measured by the first time-measuring means is ended at a moment when such a time elapses that is obtained by subtracting the ejection time from a moving time elapsing from a time when the retaining mechanism section starts a take-out operation until it arrives at the molded-product take-out position. That is, a moment when the retaining mechanism section arrives at the take-out position roughly agrees with a terminal time point of forward movement when the ejecting mechanism section terminates its ejecting operation. With this, the separation of the molded product from the die halves by the ejecting mechanism section is completed roughly at the same time as the retaining mechanism section arrives at the take-out position. Therefore, as compared to a prior art apparatus which operates according to a timing chart shown in FIG. 13, this apparatus can reduce the molded-product take-out time by an ejecting time of the ejecting mechanism section.

Also, since the ejection-waiting-time adjusting mechanism section finely adjusts the ejection waiting time so that the response time may not smaller than the absorption-pressure-rise expected time, the separation of the molded product from the die halves by the ejecting mechanism section cannot be completed before the retaining mechanism section arrives at the take-out position. Therefore, the retaining mechanism section can securely grip the molded product without encountering imperfect absorption thereof.

When the pull-out-waiting-time adjusting section has reduced the pull-out time measured by the second time-measuring means, on the other hand, the time when the retaining mechanism section stops at the molded-product take-out position roughly agrees with the absorption-pressure-rise expected time.

Further, the pull-out-waiting-time adjusting section finely adjusts the pull-out-waiting time so that a termination moment of the pull-out waiting time measured by the second time-measuring means may not be smaller than a moment of the preset pressure value detected by the absorption-pressure detecting means, so that the stopping time of the retaining mechanism section approximates an absorption-pressure-rise time elapsing until an absorption pressure of the absorbing mechanism actually reaches the preset pressure value. Therefore, a pull-out-waiting time which has been preset with a large spare time in the prior art apparatus can be nearly equal to an absorption-pressure-rise time elapsing until an absorption pressure of the absorbing mechanism actually reaches the preset pressure value, thus resulting in a great decrease in the pull-out-waiting time.

Moreover, since the pull-out-waiting-time adjusting section performs fine adjustment so that the pull-out-waiting time may not become shorter than a time when the absorption-pressure detecting means detected the preset pressure value, no pull-out operation can be started until the retaining mechanism section absorbs the molded product sufficiently.

It should be noted that the ejection waiting time and the pull-out waiting time may be reduced at a time until the response time may roughly agree with the absorption-pressure-rise expected time or gradually in several times up to a moment at which these two times agree, in which case the starting few times for gradual reduction of the time may have a large reduction ratio. In the former case where the times are reduced at a time, an optimal take-out timing can be realized from the next time of take-out operations onward. In this case, however, as described above, if an ejection time of the ejecting mechanism section is changed earlier, the ejection of the molded product may be completed before the retaining mechanism section arrives at the take-out position. If the times are reduced gradually, on the other hand, an optimal take-out timing cannot be realized unless a take-out operation is performed a few times, however, even if the ejecting time is changed earlier, the ejection of the molded product can be avoided from being completed before the retaining mechanism section arrives at the take-out position. Therefore, how to reduce the times is appropriately determined on the basis of the characteristics of the ejecting mechanism section.

Also, the ejection waiting time or the pull-out waiting time can be finely adjusted by actually increasing or decreasing the time by a predetermined small time in the next take-out operation. With this, an actual timing can be avoided from greatly deviating from the optimal take-out timing.

Having the above-mentioned configuration, the invention provides the following effects.

The ejection-waiting-time adjusting mechanism section reduces a molded-product take-out time by the ejection time. Also the pull-out-waiting-time adjusting section reduce to a minimum required value the pull-out-waiting time during which the retaining mechanism section stands still. This can greatly reduce the total time for taking out the molded product.

Also, the ejection-waiting-time adjusting section and the pull-out-waiting-time adjusting section can finely adjust the ejection-waiting time and the pull-out-waiting time respectively and automatically so that the molded product may be taken out securely.

Therefore, an efficient prolonged continuous operation can be realized even in an unmanned factory without stopping the apparatuses including the molding machine.

The other objects, features, aspects, and advantages of the invention will be more apparent from the following detailed description of embodiments with reference to the accompanying drawings.

### BRIEF DESCRIPTION OF THE DRAWINGS

FIG. 1 is a block diagram for showing a configuration of an apparatus for taking out a molded product according to an embodiment of the invention;

FIG. 2 is a graph for showing a change in an absorption pressure;

FIG. 3 is a flowchart for showing a procedure for control conducted at an ejection-waiting-time adjusting section;

FIG. 4 is a flowchart for showing a procedure for control conducted at a pull-out-waiting-time adjusting section;

FIG. 5 is a timing chart for showing a first take-out operation;

FIG. 6 is a timing chart for showing a second or subsequent take-out operation;

FIG. 7 is a timing chart for showing a take-out operation in an adjustment-stabilized state;

FIG. 8 is a block diagram for showing a configuration of an apparatus for taking out a molded product according to another embodiment;

FIG. 9 is a timing chart for showing a take-out operation in an adjustment-stabilized state in the molded-product take-out apparatus of FIG. 8;

FIG. 10 is a process drawing for showing basic operations of the take-out apparatus;

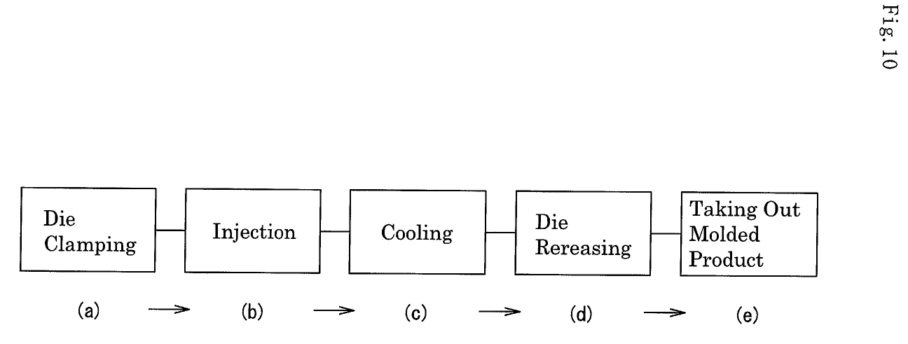

FIG. 11 is a schematic diagram for showing a configuration of the take-out apparatus;

FIG. 12 is a timing chart for showing an operation of taking out a molded product by a prior art molded-product take-out apparatus; and

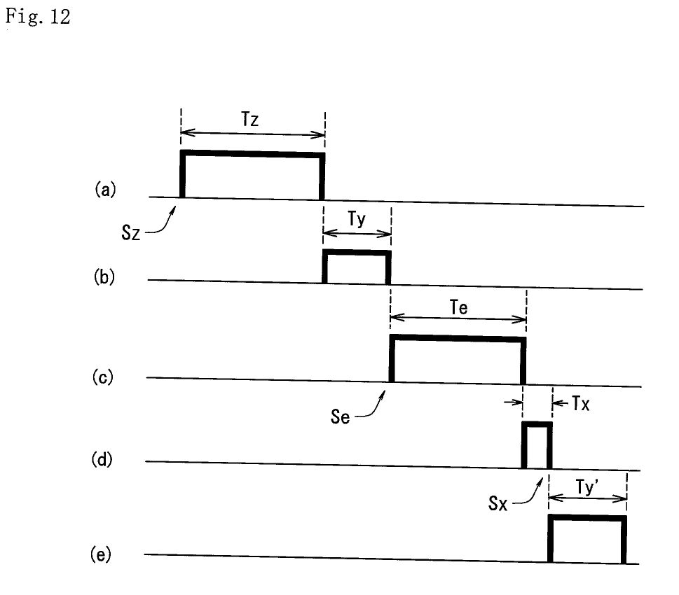

FIG. 13 is a timing chart for showing an operation of taking out a molded product by another prior art molded-product take-out apparatus.

### DESCRIPTION OF THE PREFERRED EMBODIMENTS

The following will describe embodiments of the invention with reference to the drawings.

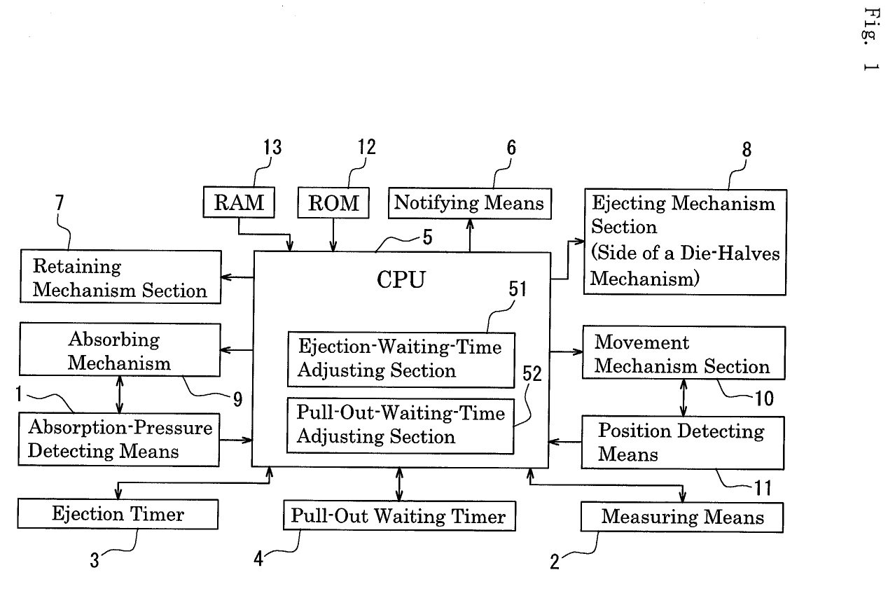

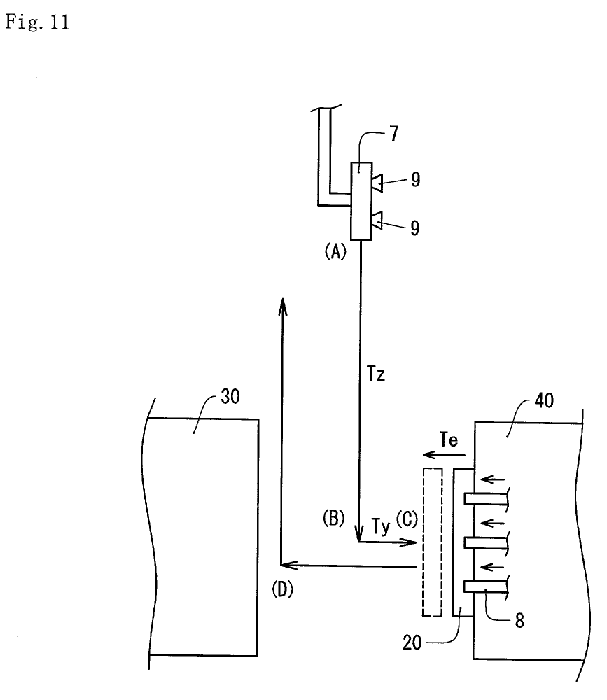

FIG. 1 is a block diagram for showing a configuration of an apparatus for taking out a molded product according to an embodiment of the invention. As shown in FIG. 1, the molded-product take-out apparatus according to the embodiment of the invention includes, like a prior art one, a retaining mechanism section 7, an absorbing mechanism 9, a movement mechanism section 10, and a position detecting means 11 as well as an absorption-pressure detecting means 1, a measuring means 2, an ejection timer (first time-measuring means) 3, a pull-out waiting timer (second time-measuring means) 4, a CPU (Central Processing Unit) 5, and a notifying means 6. It should be noted that the retaining mechanism section 7, the absorbing mechanism 9, and the movement mechanism section 10, and the position detecting means 11 are of the same configurations as those of the prior art apparatus and also that the basic operations of the take-out apparatus are such as shown in FIG. 11 in taking out at a predetermined timing a molded product 20 separated from die halves by a ejecting mechanism section 8 on the side of a die-halves mechanism.

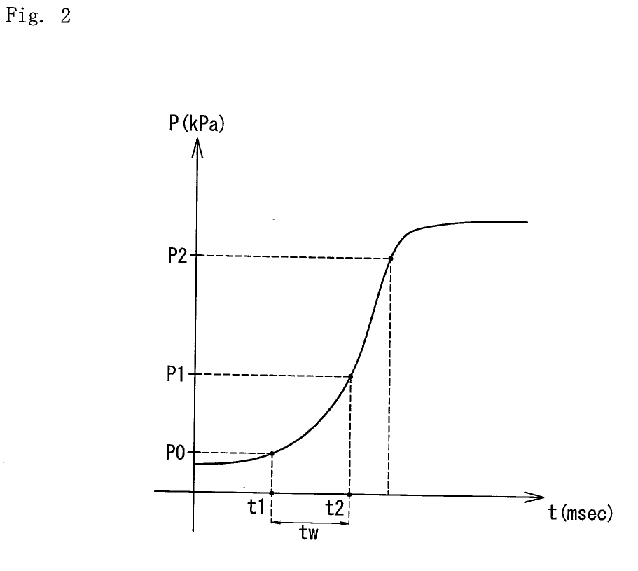

The absorption-pressure detecting means 1 serves to detect an absorption pressure of the absorbing mechanism 9 for absorbing a molded product, using, e.g., an analog or digital pressure sensor. Although this absorption-pressure detecting means 1 is adapted in this embodiment to detect an absorption pressure of the absorbing mechanism 9 at least when the retaining mechanism section 7 stands still at a take-out position, it may be adapted to detect an absorption pressure of the absorbing mechanism 9 also on its way to an opening position after the retaining mechanism section 7 has moved to a pull-out position. That is, at the take-out position, it is detected and confirmed whether the absorbing mechanism 9 has achieved a minimum required negative pressure enough to hold the molded product (e.g., whether at least a pressure value of P1 in FIG. 2 is attained), while in a way to the opening position, on the other hand, it is detected and confirmed whether the absorbing mechanism 9 has gripped the molded product securely (e.g., whether a pressure value of P2 in FIG. 2 is attained). In such a case, the absorption-pressure detecting means 1 may be equipped with two pressure sensors for detecting those two absorption pressure values or may be equipped with one pressure sensor for these respective absorption pressures.

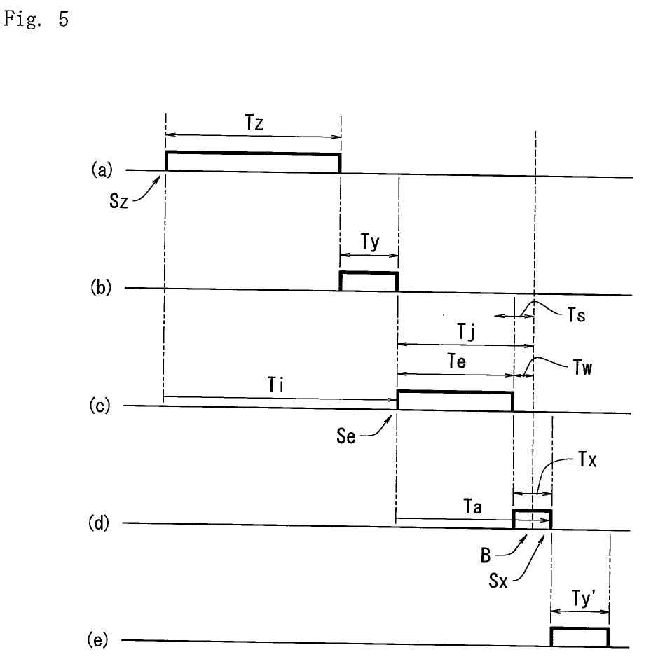

The measuring means 2 serves to measure a response time Tj elapsing from a time when the retaining mechanism section 7 arrives at a take-out position in the die cavities until a pressure value detected by the absorption-pressure detecting means 1 reaches the preset pressure value P1. This response time Tj is a total sum time of an ejecting time Te of the ejecting mechanism section 8 and an absorption-pressure rise time Tw elapsing from starting of absorbing the molded product by the absorbing mechanism 9 until its absorption pressure reaches the preset pressure value P1 if an ejection starting time of the ejecting mechanism section 8 agrees with a take-out-position arrival time of the retaining mechanism section 7 (see FIG. 5(c)).

This preset pressure value P1 means a negative pressure (vacuum pressure) which is necessary for the absorbing mechanism 9 to absorb the molded product without dropping it and is determined on the basis of experiments and experiences. That is, as shown in FIG. 2, the absorption pressure of the absorbing mechanism 9 starts to rise from a value of P0 before absorption of the molded product up to the negative pressure P1 (e.g., 30 KPa) required to absorb the molded product without go dropping it and then changes to the negative pressure P2 (e.g., 45 KPa) at which the molded product can be almost securely absorbed. Here, the negative pressure P1 shown in FIG. 2 is used as a standard of the preset pressure value. However, the preset pressure value P1 may be arbitrarily determined with a variety of products molded.

The ejection timer 3 serves to measure an ejection-waiting time Ti (e.g., see FIG. 5(c)) elapsing from a time at which the retaining mechanism section 7 starts a take-out operation until the ejecting mechanism section 8 starts its ejection operation. That is, an expiration time of this ejection timer 3 determines a moment at which is output an eject signal Se which instructs the ejecting mechanism section 8 on the die-halves mechanism side to start ejecting the molded product.

The pull-out waiting timer 4 serves to measure a pull-out waiting time Ta (e.g., see FIG. 5(d)) elapsing from an arrival time of the retaining mechanism section 7 at the molded-product take-out position until the retaining mechanism section 7 starts its pull-out operation. That is, an expiration time of this pull-out waiting timer 4 determines a moment at which is output a pull-out signal Sx which instructs the retaining mechanism section 7 to start pulling out the molded product.

The CPU5 serves to control this take-out apparatus as a whole in operation based on a program stored in a ROM12 beforehand and also to process signals based on outputs from the position detecting means 11, the ejection timer 3, and the pull-out waiting timer 4 as well as data stored in a RAM13. That is, when the ejection waiting time Ti set by the ejection timer 3 expires, the CPU5 outputs the eject signal Se which instructs the ejecting mechanism section 8 on the die mechanism side to start ejecting the molded product and, when the pull-out waiting time Ta set by the pull-out waiting timer 4 expires, outputs the pull-out signal Sx which instructs the retaining mechanism section 7 to start pulling out the molded product.

Also, the CPU5 is equipped with an ejection-waiting-time adjusting section 51 and a pull-out-waiting-time adjusting section 52.

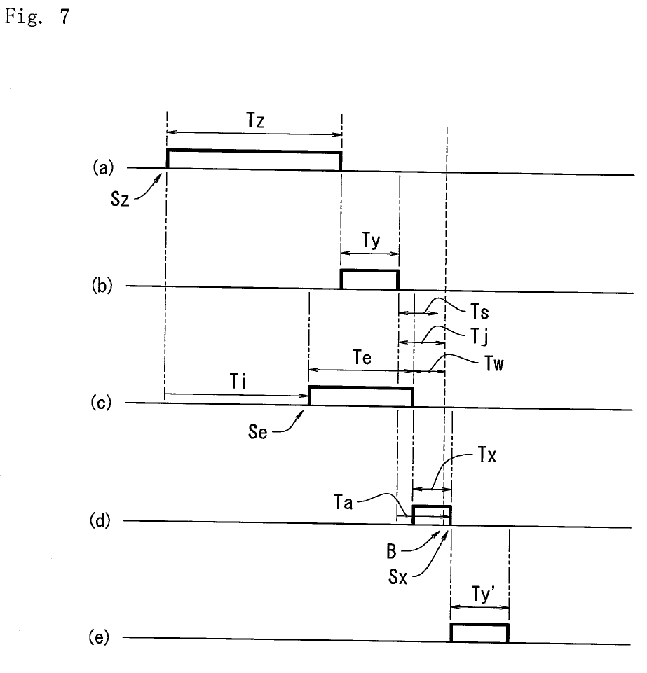

The ejection-waiting-time adjusting section 51 gradually reduces the ejection-waiting time Ti set by the ejection timer 3 as finely adjusting the time Ti so that this time Tj may not become shorter than the preset absorption-pressure-rise expected time Ts roughly when the response time Tj measured by the measuring means 2 agrees with this absorption-pressure-rise expected time Ts (see FIG. 7(c)).

Also, the pull-out-waiting-time adjusting section 52 gradually reduces the pull-out-waiting time Ta set at the pull-out waiting timer 4 as finely adjusting the time Ta so that this time Ta may not expire before a detection moment B of the preset pressure value P1 by the absorption-pressure detecting means 1 roughly when the response time Tj agrees with the absorption-pressure-rise expected time Ts (see FIG. 7(d)).

It should be noted that as shown in FIG. 2 the preset absorption-pressure-rise expected time Ts takes on such a value determined on the basis of experiments and experiences that can be considered to be an absorption-pressure-rise time Tw elapsing from a molded-product absorption-starting moment t1 of the absorbing mechanism 9 until the preset pressure value P1 arrives at a moment t2. That is, if an ejection completion moment of the ejecting mechanism section 8 agrees with a take-out position arrival moment of the retaining mechanism section 7, the retaining mechanism section 7 should idealistically stand still at the take-out position for as long as the absorption-pressure-rise time Tw, with a minimum loss in time. However, the ejecting time may vary with apparatus environments etc., so that the absorption-pressure-rise expected time Ts is preset to be longer than the absorption-pressure-rise time Tw by some spare time based on experiments and experiences. A specific set-point of this absorption-pressure-rise expected time Ts can be determined arbitrarily according to the apparatus environments etc., actually taking on a value of, e.g., 30 m sec or so as a standard.

The notifying means 6 serves to notify a possibility of improper absorption due to cracking or damaging of the absorbing mechanism 9. That is, if the number of consecutive times the pull-out waiting time Ta expires before the detecting moment B of the preset pressure value P1 by the absorption-pressure detecting means 1 after fine adjustment by the pull-out-waiting-time adjusting section 52 attains a predetermined value, the notifying means 6 notifies of a possibility of imperfect absorption such as damaging of the absorbing mechanism 9. In such a case, the notifying means 6 gives notification to the effect of a possibility of imperfect absorption. As this notifying means 6 may be used, e.g., an operating panel for displaying an error message, an alarm lamp to be turned ON, or a buzzer to be sounded, which are mounted on the apparatus. This immediately notifies the operator of a possible damages etc. of the absorbing mechanism 9 so that he can start predetermined maintenance jobs immediately to thereby minimize the down time of the apparatus, thus preventing a drop in serviceability more than necessary. Note here that the CPU5(c)ounts and decides the above-mentioned number of consecutive times.

The following will describe operations of the take-out apparatus.

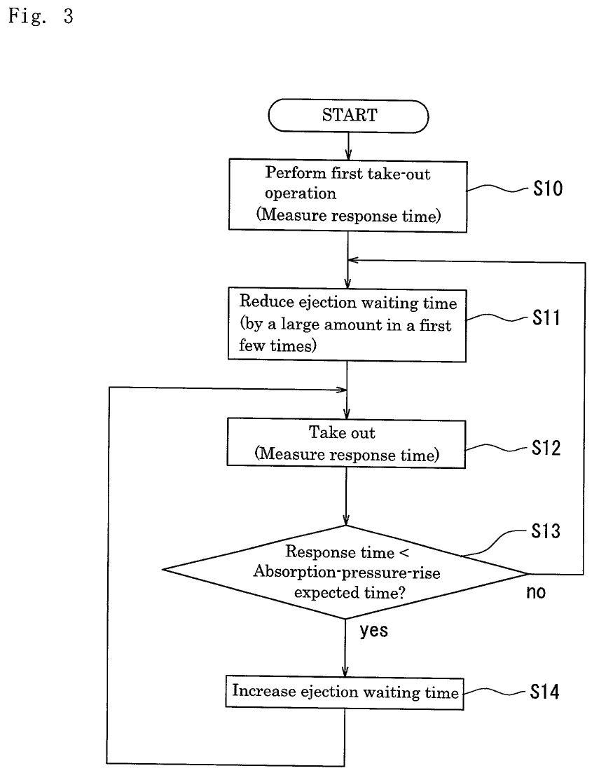

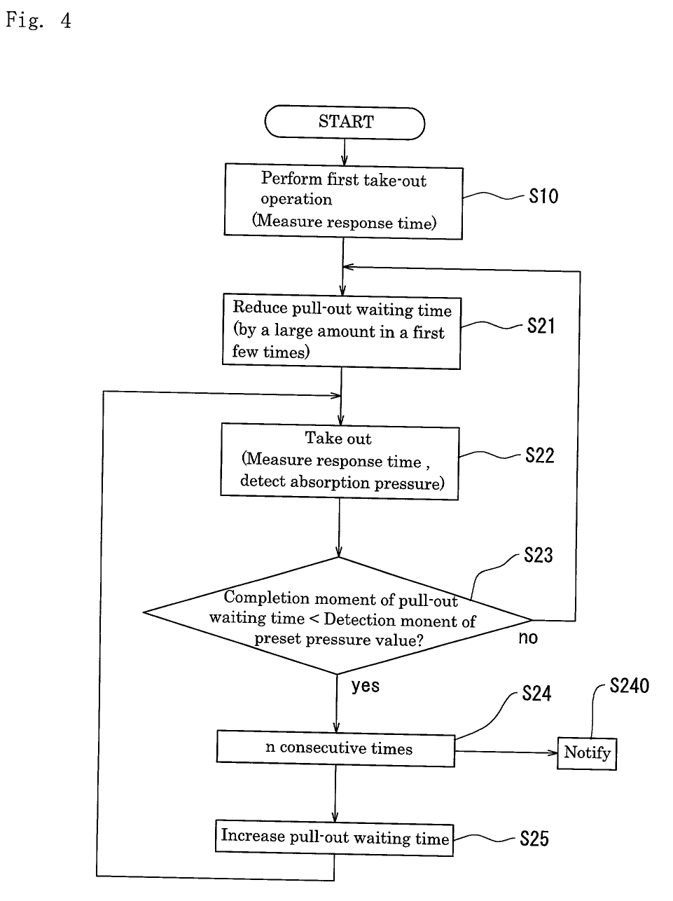

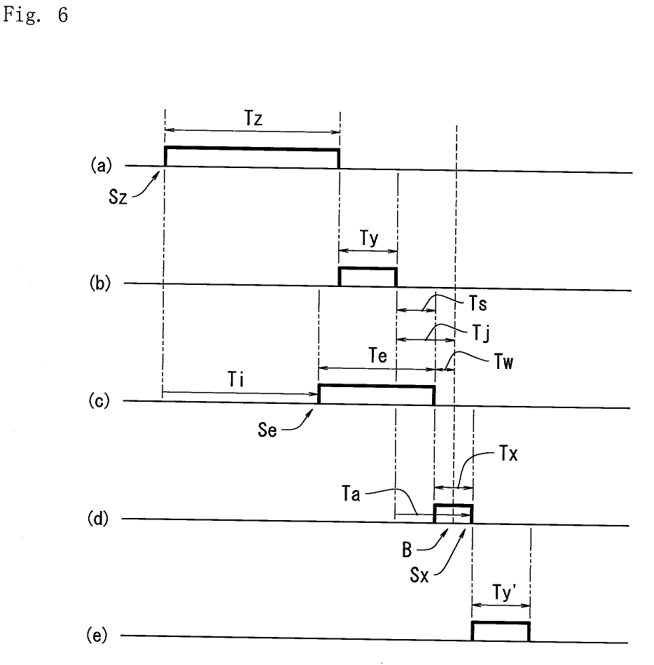

FIG. 3 shows a control flow at the ejection-waiting-time adjusting section 51 and FIG. 4 shows a control flow at the pull-out-waiting-time adjusting section 52. FIGS. 5-7 show timing charts for take-out operations under control at the ejection-waiting-time adjusting section 51 and the pull-out-waiting-time adjusting section 52, of which FIG. 5 indicates a first take-out operation, FIG. 6 indicates second and subsequent take-out operations, and FIG. 7 indicates a take-out operation in an adjustment-stabled state.

A first take-out operation accompanied by a new molding step is performed according to the timing chart of FIG. 5. That is, when the take-out signal Sz is output from the CPU5 to the movement mechanism section 10, the retaining mechanism section 7 at the waiting position starts to move toward the take-out position in the die cavities. When subsequently the position detecting means 11 has confirmed that the retaining mechanism section 7 has arrived at the take-out position, the CPU5 outputs the eject signal Se to the ejecting mechanism section 8 on the die-halves mechanism side to instruct it to start an ejection operation and instruct the measuring means 2 to start measuring time.

At the same time, the CPU5 also causes the pull-out waiting timer 4 to start measuring time. Then, the molded product ejected by the ejecting mechanism section 8 is absorbed by the absorbing mechanism 9. When the absorption-pressure detecting means 1 detects that an absorption pressure of this absorbing mechanism 9 has attained the preset pressure value P1, the CPU5 instructs the measuring means 2 to terminate time measurement. Thus, the response time Tj is measured which elapses from an arrival time of the retaining mechanism section 7 at the molded-product take-out position until a pressure value detected at the absorption-pressure detecting means 1 attains the preset pressure value P1 and is once stored in the RAM13. Afterward, when the pull-out waiting time Ta being measured at the pull-out waiting timer 4 expires, the CPU5 outputs the pull-out signal to the movement mechanism section 10. Then, after starting pulling out and having pulled out the molded product, the retaining mechanism section 7 releases the molded product at the releasing position and then returns to its initial waiting position.

The next and subsequent take-out operations are performed as follows.

As shown in FIG. 3, after the first take-out operation is performed (step S10), in the following few times of operations, the ejection-waiting-time adjusting section 51 reduces the ejection waiting time Ti set at the injection timer 3 at step S11 and then, at step S12, a series of take-out operations are performed such as movement from the waiting position to the take-out position, molded-product waiting, pull-out operation, movement to the releasing position, molded-product releasing, and returning to the waiting position. In this series of take-out operations also, the response time Tj is measured by the measuring means 2.

As shown in FIG. 6(c), the above-described time reduction is gradually performed for each take-out operation (for each take-out cycle) until the response time Tj (at the time of the previous take-out operation) measured by the measuring means 2 becomes nearly shorter than the preset absorption-pressure-rise expected time Ts. The related time-reduction ratio is larger in the first few times and smaller in the following times. This enables reducing the number of operating times required for time reduction.

Also, by gradually performing the time reduction operations in a plurality of times, even if the ejecting time by the ejecting mechanism section 8 is changed faster, it is possible to avoid the molded product from being ejected completely before the retaining mechanism section 7 arrives at the take-out position.

It should be noted that the reduced time may be, e.g., 20-30% of the response time Tj at the time of the first take-out operation in the second and third take-out operations and 3-5 m sec or so in the following take-out operations as the standard.

Then, when the ejection waiting time Ti is reduced by the ejection-waiting-time adjusting mechanism 51 so that the response time Tj may roughly agree with the absorption-pressure-rise expected time Ts as shown in FIG. 7(c), the ejection waiting time Ti of the ejection timer 3 expires (ends) at a moment Se obtained by subtracting nearly the ejecting time Te from a movement time (TZ+Ty) elapsing from starting of a take-out operation by the retaining mechanism section 7 until it arrives at the molded-product take-out position. With this, the arrival time of the retaining mechanism section 7 at the take-out position roughly agrees with the terminal point of forward movement at which the ejecting mechanism section 8 ends its ejecting operation. That is, roughly at the same time as the retaining mechanism section 7 arrives at the take-out position, the ejecting mechanism section 8 separates the molded product completely.

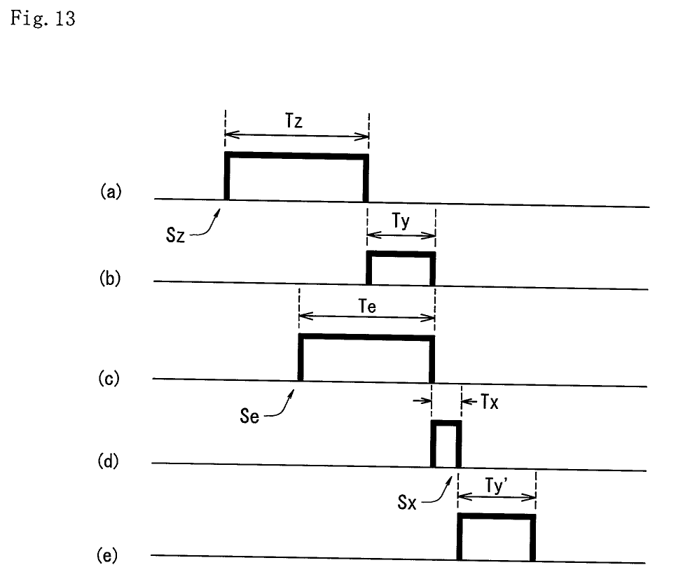

Therefore, as compared to the prior art apparatus which operates according to the timing chart of FIG. 13, the molded-product take-out time can be reduced by the ejecting time Te of the ejecting mechanism section 8. Thus, the ejection waiting time Ti can be automatically preset efficiently and accurately so as to provide roughly an idealistic optimal timing.

If the response time Tj has become shorter than the absorption-pressure-rise expected time Ts at step S13, the ejection-waiting-time adjusting section 51 increases the ejection waiting time Ti by a small time to thereby carry out the next take-out operation at step S14. If the response time Tj has become longer than the absorption-pressure-rise-expected time Ts in the next time of the take-out operation, the ejection waiting time Ti is decreased by the small time again (steps S13, S11). Thus, the ejection waiting time Ti is finely adjusted nearly when the response time Tj agrees with the absorption-pressure-rise expected time Ts, so that the separation of the molded product from the die halves by the ejecting mechanism section 8 cannot be completed before the retaining mechanism section 7 arrives at the take-out position. Therefore, the retaining mechanism section 7(c) an securely grip the molded product without improper absorption thereof. Thus, automatic adjustment can be conducted so as to maintain the ejection waiting time Ti which is preset at roughly an idealistic optimal timing. It should be noted that the small time by which the time is adjusted may be, for example, 3-5 m sec or so as a standard.

Concurrently with the automatic adjustment of the ejection waiting time Ti, the pull-out waiting time Ta is also automatically adjusted by the pull-out-waiting-time adjusting section 52 so as to provide an optimal timing. That is, as shown in FIG. 4, after the pull-out waiting time Ta of the pull-out waiting timer 4 is reduced by the pull-out-waiting-time adjusting section 5 at step S21, a take-out operation is performed at step S22. This performing of the take-out operation corresponds to step S12, involving in, as mentioned above, measurement of the response time by the measuring means 2 and detection of an absorption pressure of the absorbing mechanism 9 by the absorption-pressure detecting means 1.

As shown in FIG. 6(d), the time reducing operation is gradually performed in totally the same way as the case of the reduction ratio of the ejection waiting time Ti for each take-out operation (for each take-out cycle) until the response time Tj measured by the measuring means 2 (response time at the time of the previous take-out operation) becomes nearly shorter than the preset absorption-pressure-rise expected time Ts.

When the pull-out waiting time Ta is reduced by the pull-out-waiting-time adjusting section 52 so that the response time Tj may roughly agree with the absorption-pressure-rise expected time Ts as shown in FIG. 7(d), the pull-out waiting time Ta of the pull-out waiting timer 4 expires (ends) at a moment when the absorption-pressure-rise expected time Ts elapses after the retaining mechanism section 7 arrives at the take-out position. With this, a time during which the retaining mechanism section 7 stands still at the take-out position roughly agrees with the absorption-pressure-rise expected time Ts. Therefore, the pull-out waiting time Ta used to be preset taking into a substantial spare time into account by the prior art apparatus can be reduced greatly.

Each time the expiration moment of the pull-out waiting time Ta is decided to be earlier than the detecting moment B of the preset pressure value P1 by the absorption-pressure detecting means 1 at step S23, the number of consecutive times such event has occurred hitherto is counted by the CPU5 (step S24) and, the pull-out waiting time Ta is increased by the small time to then perform the next time of the take-out operation at step S25. If the expiration moment of the pull-out waiting time Ta becomes earlier than the detecting moment B of the preset pressure value P1 in the next time of the take-out operation, the pull-out waiting time Ta is decreased by the small time again (steps S23, S21).

It should be noted that the magnitude of the small time may be adjusted almost the same way as with the ejection waiting time Ti.

Thus, the pull-out waiting time Ta, i.e. the time during which the retaining mechanism section 7 stands still, can come approximate the absorption-pressure rise time Tw actually elapsing until an absorption pressure of the absorbing mechanism 9 attains the preset pressure value P1. At the same time, the pull-out waiting time Ta is finely adjusted nearly when the expiration moment of the pull-out waiting time Ta agrees with the detecting moment B of the preset pressure value P1, so that the pull-out operation of the molded product cannot be started if the retaining mechanism section 7 is in an imperfect absorption state.

Thus, the pull-out waiting time Ta can approximate the absorption-pressure rise time Tw, which is an idealistic waiting time with a least loss in time.

If the number of consecutive times the expiration moment of the pull-out waiting time Ta is decided at step S23 to be earlier than the detecting moment B of the preset pressure P1 by the absorption-pressure detecting means 1 even after adjustment by the pull-out-waiting-time adjusting section 52 has become n, the CPU5(d)ecides a potential imperfect absorption at the absorbing mechanism 9 owing to its crack, damage, etc. to then cause the notifying means 6 to make notification (steps S24, S240). Note here that the number of consecutive times, n, is an integer, the value of which may be set arbitrarily according to the characteristics of the absorbing mechanism 9, the apparatus, etc. The notification may be made by, for example, displaying an error message on an operating panel, turning ON an alarm lamp, or sounding an alarm buzzer mounted on the apparatus. With this, a potential of damages of the absorbing mechanism 9 can be posted immediately to the operation even in an unmanned factory so that he may starts maintenance jobs immediately.

Thus, it is possible to prevent a worst case from occurring in which abnormal breakdown of the apparatus owing to a future potential damage on the absorbing mechanism 9 may be noticed by nobody, to thereby permit immediate starting of maintenance jobs, thus minimizing the down time of the apparatus and a decrease in serviceability as well.

As described above, by this embodiment of the invention, the ejection-waiting-time adjusting section 51 reduces the molded-product take-out time by as much as the ejecting time Te, while the pull-out-waiting-time adjusting section 52 minimize the pull-out waiting time Ta during which the retaining mechanism section 9 stands still. This greatly reduces the total take-out time for the molded product.

Also, by fine adjustment performed by the ejection-waiting-time adjusting section 51 and the pull-out-waiting-time adjusting section 52, the ejection waiting time Ti and the pull-out waiting time Ta can respectively be adjusted automatically so that the molded product can be taken out securely.

Further, owing to the notifying means 6, any damages etc. on the absorbing mechanism 9 can be coped with immediately, thus minimizing a decrease in serviceability.

In view of the above, by the molded-product take-put apparatus according to the embodiment, it is possible to realize prolonged continuous operation without suspending the apparatus including a molding machine etc. even in an unmanned factory.

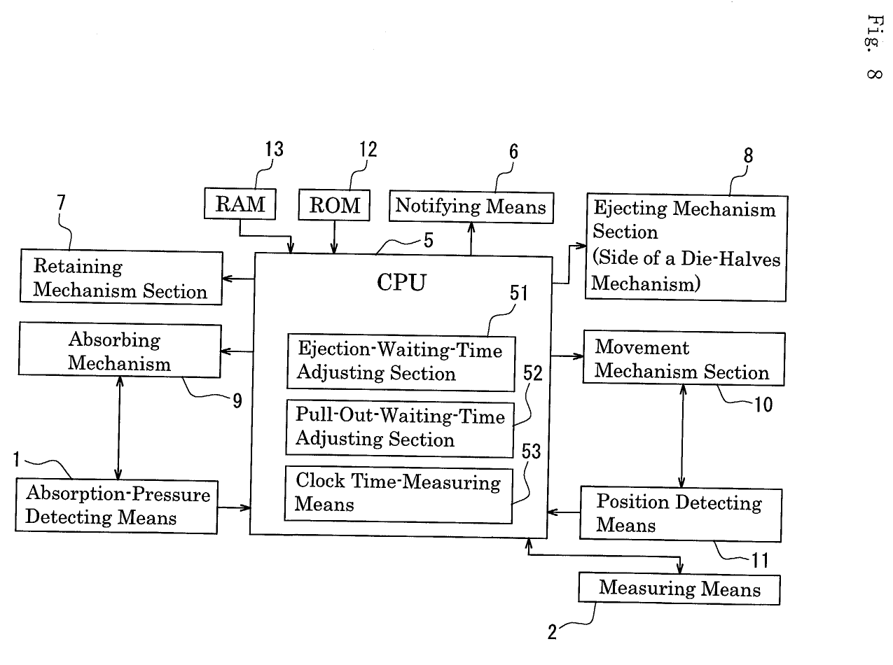

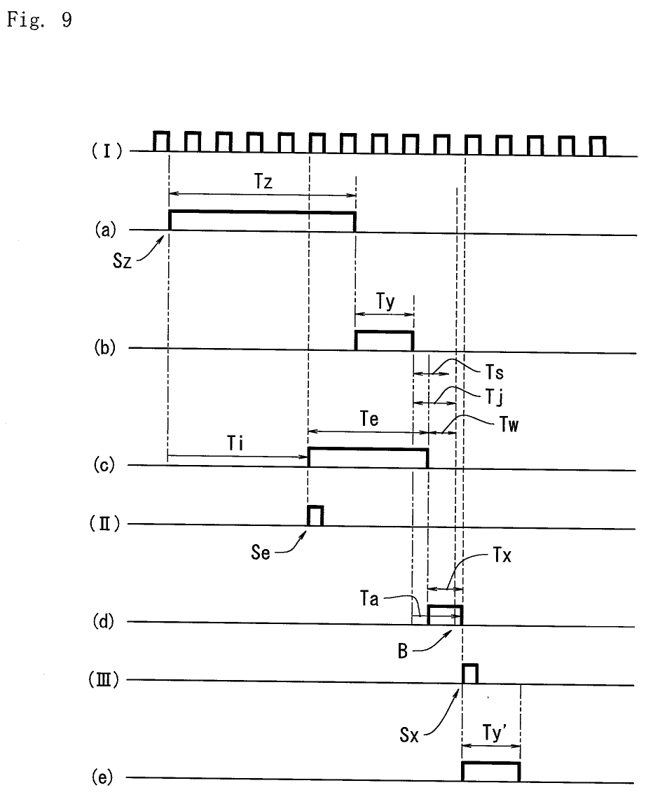

It should be noted that as shown in FIG. 8, another embodiment of the invention may replace the ejection timer 3 or the pull-out waiting timer 4 by a clock time-measuring means 53 serving similarly. In this case, as shown by the timing chart of FIG. 9, based on a clock signal such as shown in FIG. 9(I), the clock time-measuring means 53 measures the ejection waiting time Ti which determines an outputting moment of the eject signal Se (see FIG. 9(II)) as well as the pull-out waiting time Ta which determines an outputting moment of the pull-out signal Sx (see FIG. 9(III)).

Also, the ejection waiting time Ti and the pull-out waiting time Ta may be reduced at a time to such an extent that the response time Tj may roughly agree with the absorption-pressure-rise expected time Ts if the ejecting mechanism section 8 is actuated by a servo motor etc. to thereby provide only small fluctuations in its ejecting time Te. With this, in the next and subsequent take-out operations, an optimal take-out timing can be realized immediately.

Also, the time reduction ratio, which is supposed to be large in the starting few times, may have a constant value from the first time of operation. In short, how to reduce the time may be determined appropriately according to the characteristics etc. of the ejecting mechanism section 8 and the apparatus environments.

Further, the take-out apparatus according to the invention can find its application in any types of molding machines which must be opened to take out a molded product therefrom, including an injection-molding machine for molded products made of resin or metal such as magnesium, aluminum, etc.

1. An apparatus for taking out a molded product in which the molded product is separated from die halves by an ejecting mechanism section after die opening and held by a retaining mechanism section equipped with an absorbing mechanism, comprising:
absorption-pressure detecting means for detecting an absorption pressure of said absorbing mechanism having absorbed said molded product;
measuring means for measuring a response time elapsing from an arrival time of said retaining mechanism section at a molded-product take-out position until a detected pressure value of said absorption-pressure detecting means reaches a preset pressure value;
first time-measuring means for measuring an ejection waiting time elapsing from starting of an take-out operation by said retaining mechanism section until said ejecting mechanism section starts an ejection operation;
second time-measuring means for measuring a pull-out waiting time elapsing from an arrival time of said retaining mechanism section at said molded-product take-out position until said retaining mechanism section starts a pull-out operation;
an ejection waiting-time adjusting section for reducing said ejection waiting time measured by said first time-measuring means and adjusting said ejection waiting time slightly so that said response time may not become shorter than an absorption-pressure-rise expected time nearly when the response time agrees with a preset value of said absorption-pressure-rise expected time; and
a pull-out-waiting-time adjusting section for reducing said pull-out waiting time measured by the second time-measuring means and adjusting said pull-out waiting time finely so that a completion time of said pull-out waiting time may not become shorter than a detection moment of said preset pressure value by said absorption-pressure-rise detecting means.

2. The apparatus for taking out a molded product according to claim 1, further comprising:
a control section for deciding whether the number of consecutive times said completion moment of said pull-out waiting time has come earlier than said detection moment of said preset pressure value by said absorption-pressure detecting means after fine adjustment of said pill-out waiting time is performed by said pull-out-waiting-time adjusting section has attained a predetermined value; and
notifying means for notifying of imperfect absorption at said absorbing mechanism if said control section has decided that said number of consecutive times has attained said predetermined value.

3. The apparatus for taking out a molded product according to claim 1, wherein said absorption-pressure detecting means consists of a pressure sensor for detecting said absorption pressure of said absorbing mechanism while said retaining mechanism is standing at said molded-product take-out position.

4. The apparatus for taking out a molded product according to claim 1, wherein reduction of said ejection waiting time at said ejection-waiting-time adjusting section and reduction of said pull-out waiting time at said pull-out-waiting-time adjusting section are both performed until said response time may roughly agree with said absorption-pressure-rise expected time and said reductions are performed at a time in the next take-out cycle.

5. The apparatus for taking out a molded product according to claim 1, wherein reduction of said ejection waiting time at said ejection-waiting-time adjusting section and reduction of said pull-out waiting time at said pull-out-waiting-time adjusting section are both performed until said response time may roughly agree with said absorption-pressure-rise expected time and said reductions are performed gradually in several times in several take-out cycles.

6. The apparatus for taking out a molded product according to claim 5, wherein when said time reduction is performed gradually, a reduction ratio is enlarged in the starting few times.

7. The apparatus for taking out a molded product according to claim 1, wherein fine adjustment of said ejecting waiting time at said ejection-waiting-time adjusting section and fine adjustment of said pull-out waiting time at said pull-out-waiting-time adjusting section are performed by increasing or decreasing said times by a predetermined small time in the next take-out cycle.

8. The apparatus for taking out a molded product according to claim 1, wherein:
said first time-measuring means consists of an ejection timer so that an expiration moment of said timer may determine an outputting moment of an eject signal which instructs said ejecting mechanism section to start an ejection operation; and
said second time-measuring means consists of a pull-out waiting timer so that expiration of said timer may determine an outputting moment of a pull-out signal which instructs said retaining mechanism section to starts a pull-out operation.

9. The apparatus for taking out a molded product according to claim 1, wherein said first and second time-measuring means consist of clock time-measuring means so that based on a clock signal of said clock time-measuring means, an ejection waiting time may be measured at said first time-measuring means and a pull-out waiting time may be measured at said second time-measuring means.

10. The apparatus for taking out a molded product according claim 1, wherein said apparatus may be applied in taking out a molded product in an injection molding machine for molding products made of magnesium or aluminum.
